(19) United States
(12) Patent Application Publication
(10) Pub. No.: US 2010/0182267 A1
(43) Pub. Date: Jul. 22, 2010

(54) TOUCH SCREEN PANEL WITH A WINDOW

(75) Inventors: Choon-Hyop Lee, Yongin-city (KR); Jung-Mok Park, Yongin-city (KR); Sung-Ku Kang, Yongin-city (KR); Hwan-Hee Jeong, Yongin-city (KR); Tae-Hyeog Jung, Yongin-city (KR); Shawn Kim, Yongin-city (KR); Sang-Kook Kim, Yongin-city (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung Mobile Display Co., Ltd., Yongin-city (KR)

(21) Appl. No.: 12/686,967

(22) Filed: Jan. 13, 2010

(30) Foreign Application Priority Data
Jan. 16, 2009 (KR) 10-2009-0003641

(51) Int. Cl. G06F 3/041

(52) U.S. Cl. 345/173

(57) ABSTRACT

A touch screen panel is provided. The touch screen panel includes a plurality of sensing patterns formed in a display region of a transparent substrate, metal patterns arranged in a column or row in a region outside the display region and at one end of the sensing patterns, and auxiliary metal pattern arranged in a column or a row in a region outside the display region and at another end of the sensing patterns. The transparent substrate comprises a surface over which the sensing patterns are formed and disposed in a direction facing a display panel, and another surface on which a window is formed over said metal patterns and auxiliary metal patterns, said another surface disposed in a direction facing a contact object.

### CROSS-REFERENCE TO RELATED APPLICATIONS

This application claims priority to and the benefit of Korean Patent Application No. 10-2009-0003641, filed on Jan. 16, 2009, in the Korean Intellectual Property Office, the entire disclosure of which is incorporated herein by reference in its entirety.

### BACKGROUND

1. Field

The present disclosure relates to a touch screen panel, and more particularly, to a touch screen panel with a window.

2. Description of the Related Technology

A touch screen panel is an input device capable of inputting a user's instructions by selecting the content displayed on the screen of an image display device by a user's finger or an object.

To this end, the touch screen panel is typically provided on the front face of a flat panel display device to convert the contact position that directly contacts the user's finger or the object into an electrical signal. Therefore, the content selected in the contact position can be received as an input signal. A window is typically attached onto the front face of the touch screen panel that directly contacts the user's finger or the object, in order to improve hardness and to protect the touch screen panel.

Since the touch screen panel can replace an additional input device (i.e., a keyboard or a mouse) coupled to the image display device to operate, its applications are widely expanding.

When the touch screen panel is attached to the panel of the image display device, the volume of the entire image display device can increase such that facility deteriorates. Therefore, there is a need to develop a thin touch screen panel.

However, as described above, a window is typically attached onto the touch screen panel in order to protect the touch screen panel, and thus prevents the touch screen panel from being made thin.

In addition, in the conventional art, an opaque frame is typically formed in an outer region, excluding a transmitting portion of the touch screen panel (i.e., the central region of the window) and a logo is typically formed in one portion of the frame.

However, an additional process is involved to form the frame and the logo in the window so that manufacturing cost increases.

### SUMMARY OF THE INVENTION

Embodiments of the invention provide a touch screen panel with a window. The panel is made thin by use of a transparent substrate of the touch screen panel as a window, for which manufacturing processes are simplified by use of metal patterns and/or auxiliary metal patterns formed in an outer region of the transparent substrate as a frame or logo of the window.

In order to achieve the foregoing and/or other objects of embodiments of the invention, a touch screen panel is provided, the touch screen panel comprising a plurality of sensing patterns formed in a display region of a transparent substrate, metal patterns arranged in a column or a row in a region outside the display region and at one end of the sensing patterns; and auxiliary metal pattern arranged in a column or a row in a region outside the display region and at another end of the sensing patterns. The transparent substrate comprises a surface over which the sensing patterns are formed and disposed in a direction facing a display panel, and another surface on which a window is formed over said metal patterns and auxiliary metal patterns, said another surface disposed in a direction facing a contact object

In addition, the window combined touch screen panel further comprises a matrix positioned in the non-display region and including a logo engraved in a portion. Metal patterns or auxiliary metal patterns formed over a surface of the matrix are exposed on the logo.

In addition, the touch screen panel further comprises an insulating layer over the sensing patterns, a ground electrode layer over the insulating layer and a first adhesive layer interposed between the ground electrode layer and the insulating layer, and a buffer film between the first adhesive layer and the ground electrode layer.

In addition, the sensing patterns include X sensing patterns formed on one layer and Y sensing patterns formed on another layer. The X sensing patterns are patterned to be coupled to each other in a first direction and the Y sensing patterns are patterned to be coupled to each other in a second direction that intersects the first direction.

According to an embodiment, a touch screen panel comprises a substrate comprising a first surface and a second surface, a plurality of sensors disposed over the first surface in a display region of the substrate, and a matrix disposed over the first surface in a non-display region of the substrate, wherein the second surface comprises a contact surface over the plurality of sensors and a window surface over the matrix.

In addition, the substrate is transparent. The touch screen panel further comprises metal structures disposed over the matrix over the first surface. The touch screen panel further comprises an insulating layer disposed over the first surface, wherein at least a portion of the sensors and at least a portion of the metal structures are formed within the insulating layer, an adhesive layer disposed over the insulating layer, and a ground electrode layer disposed over the adhesive layer.

According to an embodiment, a touch screen panel comprises a transparent substrate, a plurality of sensors disposed over a surface of the substrate on a region of the substrate, and a matrix disposed over the surface on another region of the substrate, wherein the region with the sensors provides a contact region and the region with the matrix provides a frame region.

In addition, the contact and frame regions are located on a surface of the substrate opposite to the surface over which the sensors and the matrix are disposed.

In addition, the plurality of sensors comprises a first group of sensors arranged in a first direction and a second group of sensors arranged in a second direction that intersects the first direction. The first group of sensors is coupled to a first group of metal structures disposed over the matrix, and the second group of sensors is coupled to a second group of metal structures disposed over the matrix.

In addition, the first group of sensors and the metal structures are formed on an insulating layer. The plurality of sensors comprises a first group of sensors formed on a first insulating layer and a second group of sensors formed on a second insulating layer.

According to an embodiment, a method of manufacturing a touch screen panel comprises forming the metal patterns and/or the auxiliary metal pattern in an outer region of the transparent substrate as a frame or logo of the window.

As described above, according to the present invention, the touch screen panel can be made thin by using the transparent substrate of the touch screen panel as the window. In addition, the metal patterns or the auxiliary metal patterns formed in an outer region of the transparent substrate are used as a frame or logo of the window, thereby facilitating the manufacturing processes and reducing the manufacturing cost.

### BRIEF DESCRIPTION OF THE DRAWINGS

The accompanying drawings and specification illustrate embodiments of the present invention and serve to explain the principles of embodiments of the invention.

FIGS. 1A and 1B are a front view and a rear view schematically illustrating a touch screen panel according to an embodiment of the invention;

FIG. 2 is a cross-sectional view illustrating a main part of a touch screen panel according to an embodiment of the invention; and

FIG. 3 is a cross-sectional view illustrating a main part of a touch screen panel according to another embodiment of the invention.

### DETAILED DESCRIPTION OF THE PREFERRED EMBODIMENT

In the following detailed description, only certain embodiments of the invention have been shown and described, simply by way of illustration. As those skilled in the art would realize, the described embodiments may be modified in various different ways, all without departing from the spirit or scope of the invention. Accordingly, the drawings and description are to be regarded as illustrative in nature and not restrictive. In addition, when an element is referred to as being “on” another element, it can be directly on another element or be indirectly on another element with one or more intervening elements interposed therebetween. Also, when an element is referred to as being “coupled to” another element, it can be directly coupled to another element or indirectly coupled to another element with one or more intervening elements interposed therebetween. Hereinafter, like reference numerals refer to like elements.

Embodiments of the invention will be described in detail with reference to the accompanying drawings.

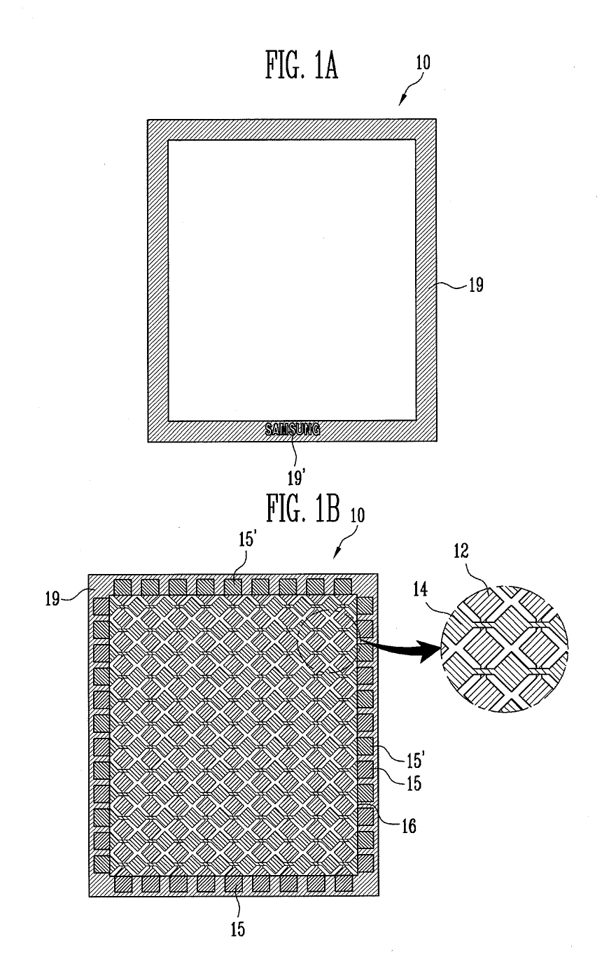

FIGS. 1A and 1B are plan views schematically illustrating a touch screen panel according to an embodiment of the invention. FIG. 1A is a front view, and FIG. 1B is a rear view.

Referring to FIG. 1A, an embodiment includes a black matrix 19 in an outer region of a transparent substrate 10 and a logo 19′ engraved in a portion of the black matrix 19 on the transparent substrate 10, which functions as a window on the front surface of the touch screen panel.

The black matrix 19 can be formed in the non-display region, or a frame of the transparent substrate. The metal patterns (not shown) or the auxiliary metal patterns (not shown) formed under the logo 19′ engraved in the portion of the black matrix may be exposed to be displayed on the logo 19′.

At this time, the black matrix 19 need not be formed. In this case, the metal patterns or the auxiliary metal patterns formed in the black matrix region can function as the black matrix 19.

As described above, according to an embodiment, conventional process steps additionally performed to form the frame and the logo of the window can be excluded so that processes can be simplified and manufacturing costs reduced.

FIG. 1B illustrates the structure of the rear surface of the touch screen panel according to an embodiment of the invention.

Referring to FIG. 1B, the touch screen panel can include a plurality of sensing patterns 12 and 14 formed in the display region of the transparent substrate 10, the black matrix 19 formed outside the display region, or in the non-display region, metal patterns 15 formed in the non-display region and at one end portion of the sensing patterns 12 and 14 in a column or a row, to couple the sensing patterns 12 and 14 to position detecting lines (not shown), auxiliary metal patterns 15′ formed at the other end portion of the sensing patterns 12 and 14 in a column or a row, and an insulating layer 16 formed to cover the sensing patterns 12 and 14.

According to an embodiment, the sensing patterns 12 and 14 can include X sensing patterns 12 and Y sensing patterns 14 arranged to alternate each other, such that X sensing patterns 12 have the same X coordinate coupled to each other by column and Y sensing patterns 14 have the same Y coordinate coupled to each other by row.

For example, the X sensing patterns 12 can include a plurality of X patterns formed such that sensing patterns having the same X coordinate in one column are coupled to each other in a first direction (a column direction). The Y sensing patterns 14 can include a plurality of Y patterns formed such that sensing patterns having the same Y coordinate in one row can be coupled to each other in a second direction (a row direction).

The X and Y sensing patterns 12 and 14 can be formed on different layers with an additional insulating layer (not shown) interposed therebetween.

A patterning process according to an embodiment, the X sensing patterns 12 can be patterned to be coupled to each other in the first direction, and the Y sensing patterns 14 can be patterned to be coupled to each other in the second direction. Therefore, additional processes of forming a contact hole and coupling patterns can be omitted so that fewer masks are used and the manufacturing process is simplified.

However, it should be noted that the aforementioned process is only an illustrative embodiment but does not limit the present invention.

For example, the X and Y sensing patterns 12 and 14 may be formed on the same layer. In an embodiment, one of the X and Y sensing patterns 12 and 14 may be formed to be coupled to each other in the first or second direction in the patterning process and the other thereof may be coupled to each other in the first or second direction in the processes of forming the contact hole and the coupling patterns.

In addition, the metal patterns 15 may be arranged at an edge of the region where the X and Y sensing patterns 12 and 14 may be formed to couple the X and Y sensing patterns 12 and 14 to position detecting lines (not shown).

To be specific, the metal patterns 15 can electrically couple the X and Y sensing patterns 12 and 14 by column or row to the position detecting lines so that a contact position detecting signal can be supplied to a driving circuit.

According to an embodiment, the auxiliary metal patterns 15′ can be made of the same material as the metal patterns 15 are further formed at edge of the X and Y sensing patterns where the metal patterns 15 are not formed.

As illustrated in the drawing, the metal patterns 15 can be formed at the lower end of the panel to couple the X sensing patterns 12 with the position detecting lines and can be alternately formed on the left and right of the panel in a row to couple the Y sensing patterns 14 to the position detecting lines.

This is because the X and Y sensing patterns 12 and 14 in a column or row can be coupled to the position detecting lines when the metal patterns 15 are formed only at one end portions of the X and Y sensing patterns 12 and 14 in a column or a row. Therefore, the metal patterns 15 do not need providing on the opposite sides of the one end portion, or at the other end portion of the X and Y sensing patterns 12 and 14 in a column or a row where the metal patterns 15 are formed.

However, according to an embodiment, the auxiliary metal patterns 15′ can be additionally formed at the other end portions of the X and Y sensing patterns 12 and 14 in a column or a row. Therefore, the metal patterns 15 and the auxiliary metal patterns 15′ can be formed on the front surface of the non-display region.

As described above, the metal patterns 15 and the auxiliary metal patterns 15′ can be formed in the region that overlaps the black matrix 19 formed in the non-display region. Therefore, the metal patterns 15 or the auxiliary metal patterns 15′ can be exposed through the logo 19′ engraved in the portion of the black matrix 19 so that the logo is clearly displayed.

In addition, the insulating layer 16 can be made of a transparent insulating material that covers the sensing patterns 12 and 14.

When a contact object such as a user's finger or a touch stick contacts the touch screen panel as an electrostatic capacity type touch screen panel, a change in electrostatic capacity in accordance with a contact position can be transmitted from the sensing patterns 12 and 14 to the driving circuit via the metal patterns 15 and the position detecting lines. The change in the electrostatic capacity can be converted into an electric signal by an X and Y input processing circuits (not shown) so that the contact position is detected.

According to an embodiment, the sensing patterns 12 and 14 can be arranged in the direction of a display panel (not shown) such as a liquid crystal display (LCD). That is, when the display panel is positioned under the touch screen panel and the contact surface is the upper surface of the touch screen panel, the sensing patterns 12 and 14 can be formed under the transparent substrate 10. The upper surface of the transparent substrate 10, as the surface that a contact object may contact, can function as the window of the display device.

According to an embodiment, an additional window is not provided but the transparent substrate of the touch screen panel can be combined with the window. Therefore, the touch screen panel can be thin and manufacturing efficiency can be improved as the manufacturing processes are simplified, and material costs reduced.

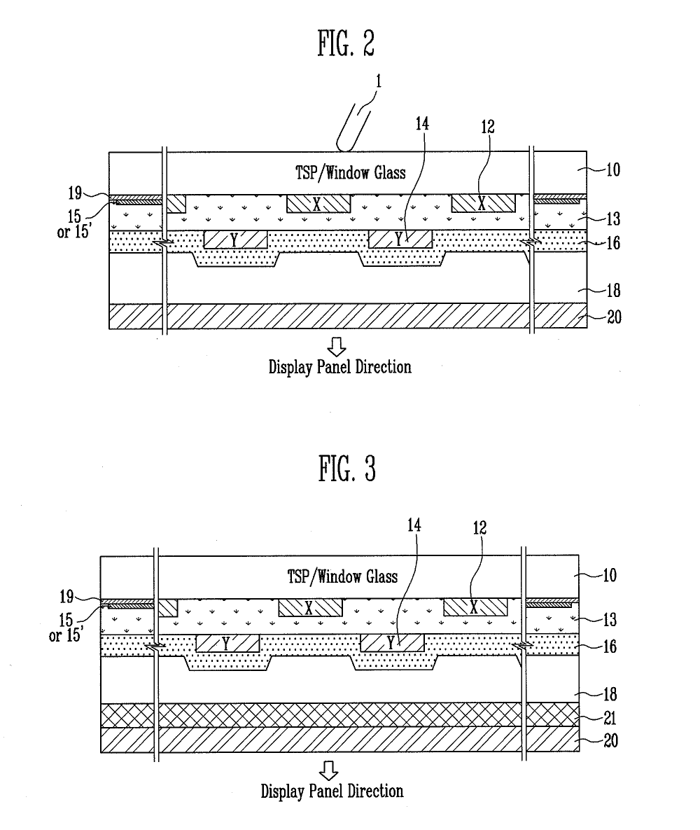

FIG. 2 is a cross-sectional view illustrating the main part of a touch screen panel according to a first embodiment.

Referring to FIG. 2, the touch screen panel according to the first embodiment can be divided into a display region and a non-display region. The display region includes sensing patterns 12 and 14, a second insulating layer 16, a first adhesive layer 18, and a ground electrode layer 20, which are sequentially formed over one surface of the transparent substrate 10. The non-display region, outside the display region, can include a black matrix 19, metal patterns 15 and auxiliary metal patterns 15′, first and second insulating layers 13 and 16, a first adhesive layer 18, and a ground electrode layer 20, which may be sequentially formed over one surface of the transparent substrate 10.

In the illustrated embodiment, the surface of the transparent substrate 10 on which the sensing patterns 12 and 14, the black matrix 19, the metal patterns 15, the auxiliary metal patterns 15′, the second insulating layer 16, the first adhesive layer 18, and the ground electrode layer 20 can be formed is one surface to a display panel, for example, a lower surface. The other surface of the transparent substrate 10 can be provided in the direction where a contact object 1 contacts, for example, an upper surface. That is, the transparent substrate 10 can be combined with the window.

The transparent substrate 10 may be made of a material such as glass. However, the transparent substrate 10 may be formed of another transparent substrate other than glass. Here, the term “transparent” comprehensively refers to not only having 100% transparency but transparency with high transmittance.

The sensing patterns 12 and 14 can be alternately arranged on different layers with a first insulating layer 13 made of a transparent material interposed therebetween. However, the present invention is not limited to the above but the sensing patterns 12 and 14 may be arranged on the same layer.

The sensing patterns 12 and 14 can be made of a transparent electrode material such as indium tin oxide (ITO) so that light emitted from the display panel provided under the touch screen panel can transmit the touch screen panel.

The sensing patterns 12 and 14 can be covered with the second insulting layer 16 made of a transparent material.

The first adhesive layer 18 can be formed between the second insulating layer 16 and the ground electrode layer 20 to adhere the second insulating layer 16 and the ground electrode layer 20 to each other. The first adhesive layer 18 can be made of a transparent adhesive material having high transmittance. For example, the first adhesive layer 18 can be made of super view resin (SVR) and optical cleared adhesive (OCA).

The ground electrode layer 20 can be made of a transparent electrode material such as ITO and can be formed to face the second insulating layer 16 with the first adhesive layer 18 interposed therebetween. The ground electrode layer 20 can be used for securing stability between the touch screen panel and the display panel and can be used for forming electrostatic capacity with the sensing patterns 12 and 14 depending on a designing method of the touch screen panel.

That is, in an electrostatic capacity type touch screen panel, electrostatic capacity between the X and Y sensing patterns 12 and 14 and the ground electrode layer 20 can be used to sense the contact position.

On the other hand, the ground electrode layer 20 may not be provided in the touch screen panel but may be provided on the surface of the display panel coupled to the touch screen panel.

According to the present invention having the above-described structure, the transparent substrate 10 of the touch screen panel and the window can be combined with each other.

FIG. 3 is a cross-sectional view illustrating the main part of a touch screen panel according to another embodiment of the present invention. In describing FIG. 3, the same elements as those of FIG. 2 are denoted by the same reference numerals and detailed description thereof will not be discussed.

Referring to FIG. 3, the touch screen panel according to another embodiment can further include a buffer film 21 formed under the second insulating layer 16.

Specifically, the buffer film 21 can be formed on the lower surface (the surface that faces the display panel) of the first adhesive layer 18 to be attached onto the touch screen panel and can be formed between the first adhesive layer 18 and the ground electrode layer 20.

The buffer film 21 can be made of a polymer material such as polyethylene terephthalate (PET) not to be dispersed and to improve the durability of the touch screen panel.

Furthermore, the buffer film 21 can improve the sensitivity of the touch screen panel. Specifically, when the buffer film 21 is provided, the distance between the sensing patterns 12 and 14 and the ground electrode layer 20 may increase so that the electrostatic capacity formed between the sensing patterns 12 and 14 and the ground electrode layer 20 can be reduced. Therefore, since the touch screen panel more sensitively reacts to contact to the same degree, a highly sensitive touch screen panel can be realized.

While embodiments have been described in connection with certain embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel, comprising:
a plurality of sensing patterns formed in a display region of a transparent substrate;
metal patterns arranged in a column or row in a region outside the display region and at one end of the sensing patterns; and
auxiliary metal patterns arranged in a column or a row in a region outside the display region and at another end of the sensing patterns,
wherein the transparent substrate comprises a surface over which the sensing patterns are formed and disposed in a direction facing a display panel, and another surface on which a window is formed over said metal patterns and auxiliary metal patterns, said another surface disposed in a direction facing a contact object.

2. The touch screen panel of claim 1, further comprising a matrix positioned in the non-display region, wherein the matrix comprises a portion that includes a logo engraved in the portion.

3. The touch screen panel of claim 2, wherein the metal patterns or the auxiliary metal patterns are formed over a surface of the black matrix and are exposed on the logo.

4. The touch screen panel of claim 1, further comprising:
an insulating layer over the sensing patterns; and
a ground electrode layer over the insulating layer; and
a first adhesive layer interposed between the ground electrode layer and the insulating layer.

5. The touch screen panel of claim 4, further comprising a buffer film between the first adhesive layer and the ground electrode layer.

6. The touch screen panel of claim 1, wherein the sensing patterns comprise X sensing patterns formed on one layer and Y sensing patterns formed on another layer.

7. The touch screen panel as claimed in claim 6,
wherein the X sensing patterns are patterned to be coupled to each other in a first direction, and
wherein the Y sensing patterns are patterned to be coupled to each other in a second direction that intersects the first direction.

8. A touch screen panel comprising:
a substrate comprising a first surface and a second surface;
a plurality of sensors disposed over the first surface in a display region of the substrate; and
a matrix disposed over the first surface in a non-display region of the substrate;
wherein the second surface comprises a contact surface over the plurality of sensors and a window surface over the matrix.

9. The touch screen panel of claim 8, wherein the substrate is transparent.

10. The touch screen panel of claim 8, further comprising metal structures disposed over the matrix over the first surface.

11. The touch screen panel of claim 10, further comprising an insulating layer disposed over the first surface, wherein at least a portion of the sensors and at least a portion of the metal structures are formed within the insulating layer.

12. The touch screen panel of claim 11, further comprising an adhesive layer disposed over the insulating layer.

13. The touch screen panel of claim 12, further comprising a ground electrode layer disposed over the adhesive layer.

14. A touch screen panel comprising:
a transparent substrate;
a plurality of sensors disposed over a surface of the substrate on a region of the substrate; and
a matrix disposed over the surface on another region of the substrate;
wherein the region with the sensors provides a contact region and the region with the matrix provides a frame region.

15. The touch screen panel of claim 14, wherein the contact and frame regions are located on a surface of the substrate opposite to the surface over which the sensors and the matrix are disposed.

16. The touch screen panel of claim 14, wherein the plurality of sensors comprises a first group of sensors arranged in a first direction and a second group of sensors arranged in a second direction that intersects the first direction.

17. The touch screen panel of claim 16, wherein the first group of sensors is coupled to a first group of metal structures disposed over the matrix, and the second group of sensors is coupled to a second group of metal structures disposed over the matrix.

18. The touch screen panel of claim 17, wherein the first group of sensors and the metal structures are formed on an insulating layer.

19. The touch screen panel of claim 14, wherein the plurality of sensors comprises a first group of sensors formed on a first insulating layer and a second group of sensors formed on a second insulating layer.

20. A method of manufacturing the touch screen panel of claim 1, comprising forming the metal patterns or the auxiliary metal pattern in an outer region of the transparent substrate as a frame or logo of the window.
